(19) United States
(12) Patent Application Publication
(10) Pub. No.: US 2025/0239745 A1
(43) Pub. Date: Jul. 24, 2025

(54) SYSTEMS AND METHODS OF FOLDING ELECTROCHEMICAL CELL TABS FOR ENERGY DENSITY IMPROVEMENT

(71) Applicant: 24M Technologies, Inc., Cambridge, MA (US)

(72) Inventors: Ryan Michael LAWRENCE, Watertown, MA (US); Madeleine FINKENAUR, Somerville, MA (US)

(21) Appl. No.: 19/029,542

(22) Filed: Jan. 17, 2025

Related U.S. Application Data
(60) Provisional application No. 63/622,201, filed on Jan. 18, 2024.

(51) Int. Cl. H01M 50/54; H01M 50/105; H01M 50/178; H01M 50/533; H01M 50/536; H01M 50/55

(52) U.S. Cl. CPC H01M 50/54; H01M 50/105; H01M 50/178; H01M 50/533; H01M 50/536; H01M 50/55

(57) ABSTRACT

Embodiments described herein relate to electrochemical cells and/or electrochemical cell assemblies (e.g., stacks) or systems with folded tabs, and methods of assembling and sealing the same. In some aspects, an electrochemical cell can include a first electrode, a second electrode different than the first electrode, a separator between the first electrode and the second electrode, and an electrode tab electrically coupled to at least one of the first electrode or the second electrode, at least a portion of the electrode tab folded to form a folded portion. In some aspects, a method can include loading an electrode stack into a stack pouch bottom, folding cell terminals of the electrode stack over an edge of the stack pouch bottom, applying a stack pouch top to the electrode stack opposite of the stack pouch bottom, and sealing the folded cell terminals between the stack pouch bottom and the stack pouch top.

### CROSS-REFERENCE TO RELATED APPLICATIONS

This application claims priority to and the benefit of U.S. Provisional Application No. 63/622,201, filed Jan. 18, 2024, and entitled “Systems and Methods of Folding Electrochemical Cell Tabs for Energy Density Improvement,” the entire disclosure of which is hereby incorporated by reference herein.

### TECHNICAL FIELD

Embodiments described herein relate to assembling and sealing electrochemical cell pouches.

### BACKGROUND

Certain electrochemical cell pouches include a seal around the perimeter of each anode-cathode pair. Current assembly processes, however, generate inactive volume (e.g., dead space, empty space, etc.) in the electrochemical cell that reduces the volumetric energy density. While current sealing processes secure separators in place and permanently separates the electrodes, an assembly process that maintains or increases the volumetric energy density of electrochemical cells is desirable.

### SUMMARY

Embodiments described herein relate to electrochemical cells and/or electrochemical cell assemblies (e.g., stacks) or systems with folded tabs, and methods of assembling and sealing the same. In some aspects, an electrochemical cell can include a first electrode, a second electrode different than the first electrode, a separator between the first electrode and the second electrode, and an electrode tab electrically coupled to at least one of the first electrode or the second electrode, at least a portion of the electrode tab folded to form a folded portion.

In some aspects, an electrochemical cell assembly can include a first electrode paired with a second electrode via a separator, the first electrode, second electrode, and separator collectively forming a unit cell, a pouch defining an internal volume within which the unit cell is disposed, a tab extending from the unit cell to a region outside of the internal volume, the tab electrically coupled to at least one of the first electrode or the second electrode, a portion of the tab disposed at least partially outside the internal volume being folded to form a folded portion, and a terminal assembly disposed outside the internal volume, the terminal assembly including a terminal tab electrically coupled to the folded portion of the tab.

In some aspects, a method can include loading an electrode stack into a pouch bottom, folding the tabs of the electrode stack over an edge of the pouch bottom, applying a pouch top to the electrode stack opposite of the pouch bottom, and sealing the cell terminals between the pouch bottom and the pouch top, thus securing the folded electrode tabs in place.

### BRIEF DESCRIPTION OF THE DRAWINGS

FIGS. 1A-1D are illustrations of a conventional electrode stack and corresponding cell assembly method, according to an embodiment.

FIGS. 2A-2G are illustrations of an electrode stack with an added seal and corresponding cell assembly method including folded electrode tabs, according to an embodiment.

FIGS. 3A-3C are illustrations of a top view of a method of forming and folding an electrochemical cell terminal assembly, according to an embodiment.

FIGS. 4A-4C are illustrations of a side view of a method of folding an electrochemical cell terminal assembly, according to embodiment.

FIGS. 5A-5B are images of a perspective view of a method of folding an electrochemical cell terminal assembly, according to an embodiment.

FIG. 6 is a block diagram of a method of preparing and sealing an electrochemical cell pouch, according to an embodiment.

FIGS. 7A-7N are illustrations of the steps of a method of preparing, folding, and sealing cell terminal assemblies into an electrochemical cell pouch.

FIG. 8 is an image of an electrochemical cell in an electrochemical cell terminal assembly folding device, according to an embodiment.

### DETAILED DESCRIPTION

Embodiments described herein relate to assembling and sealing electrochemical cell pouches. Electrochemical cells are often used in applications where volumetric energy density is important. The importance of volumetric energy density is further amplified when multiple electrochemical cells are used in tandem. Embodiments described herein include the use of a fold in the terminals, for example, tabs of an electrochemical cell to increase the volumetric energy density and reduce space occupied by the electrochemical cell(s) or cell assemblies including a plurality of electrochemical cells in a package, thereby reducing inactive volume.

In some embodiments, terminals (e.g., tabs coupled to current collectors) are folded, for example, into a z-fold (e.g., a fold that appears to form or resemble the letter “Z”). In some embodiments, the terminals may be folded such that the terminals are level with the mid-plane of the electrode stack and in contact with a unit cell seal (i.e., a unit cell pouch seal that seals a unit cell inside a pouch). In some embodiments, the unit cell seal includes a heat seal. In some embodiments, a stack of unit cells can be sealed together inside of a secondary pouch casing. The folded terminals may be positioned such that the secondary pouch seal secures the terminals in a folded position. In some embodiments, the unit cell seal overlaps a coupling region (e.g., a terminal weld) of the terminals. Sealing the terminals in a folded position increases the volumetric energy density of the electrochemical cell by reducing the proportion of dead space or dead volume (e.g., space not used for battery operation).

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. In some embodiments, the electrodes included in the electrochemical cells described herein may include conventional solid electrodes, for example, electrodes including binders.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (e.g., anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used in this specification, a “unit cell” refers to a single electrochemical cell including an anode and a cathode with a separator disposed therebetween. Multiple unit cells can be stacked together to form an electrochemical cell stack or a unit cell stack.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “electrochemical cell” refers to a device that converts chemical energy to electrical energy. Electrochemical cells can include an anode (e.g., negative terminal) and a cathode (e.g., positive terminal), which may be collectively known as “terminals”. When connected, current may flow between the terminals. Connecting electrochemical cells in parallel, series, or any combination thereof forms a battery.

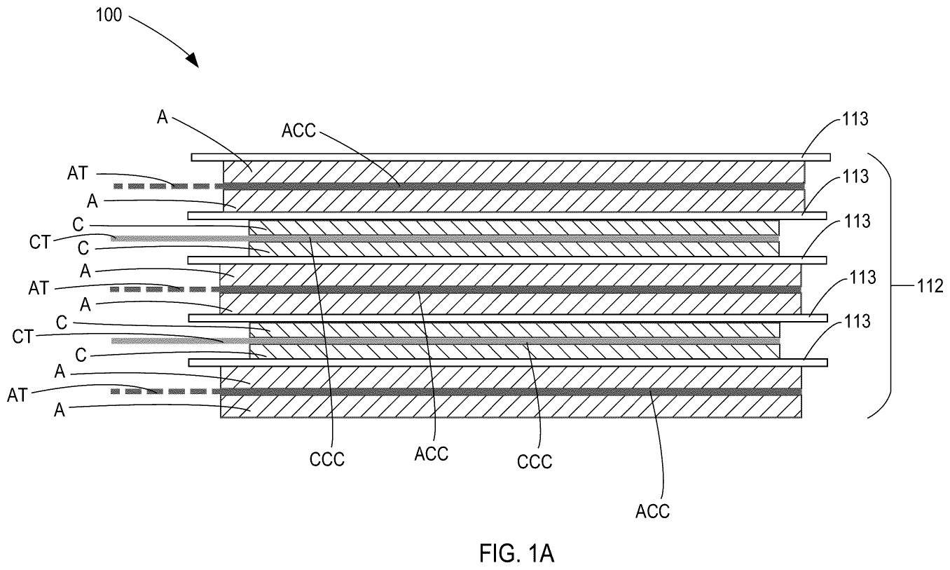

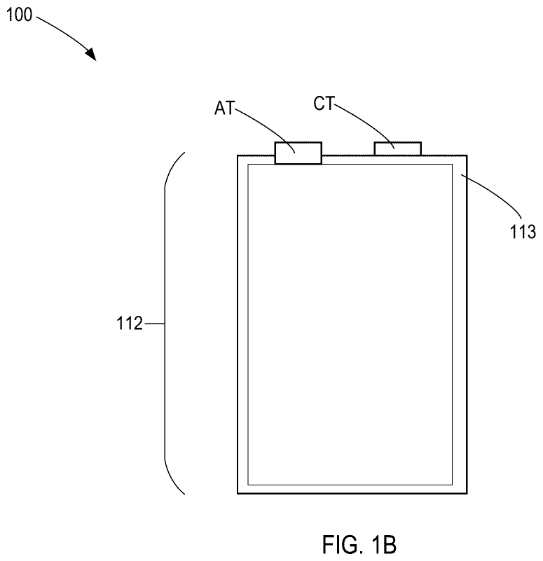

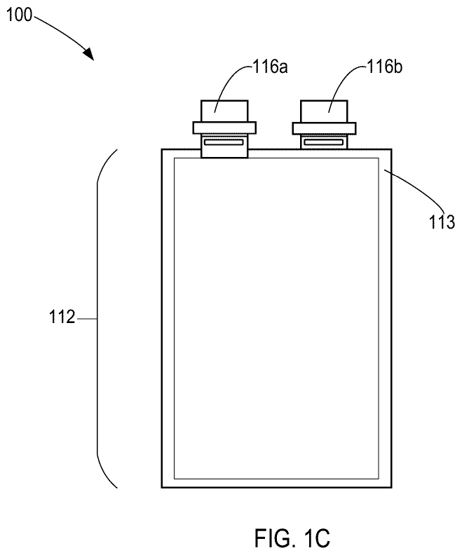

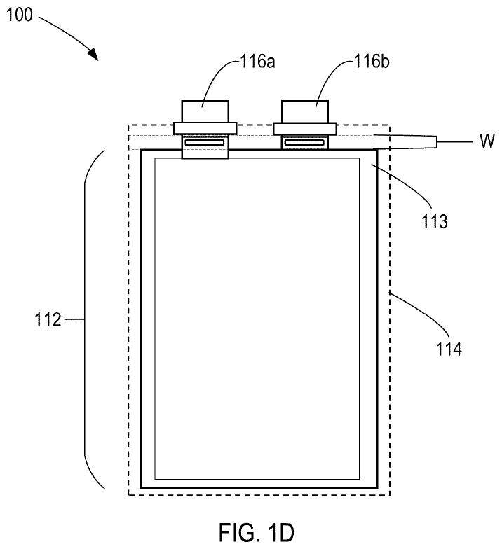

FIGS. 1A-1D are illustrations of a conventional electrochemical cell stack 100 and the construction thereof, according to an embodiment. The electrochemical cell stack 100 includes an electrode stack 112 disposed within a stack pouch 114. The electrode stack 112 may include at least one anode A, at least one cathode C, at least one anode current collector ACC with an anode tab AT, at least one cathode current collector CCC with a cathode tab CT, and a separator 113 disposed between each anode A and cathode C. In some embodiments, the electrode stack 112 may include a series of anodes A, cathodes C, and/or separators 113. Extending away from the electrode stack 112 are two terminals 116a, 116b (collectively referred to as “terminals 116”) that operate as collective current collectors. The terminal 116a serves as a negative terminal (e.g., electrically connected to the anodes A of the electrode stack 112) and the terminal 116b serves as a positive terminal (e.g., electrically connected to the cathodes C of the electrode stack 112).

In some embodiments, the terminal 116a may be a positive terminal and the terminal 116b may be a negative terminal. The terminals 116 may include a tab that extends away from the electrode stack 112 and an extension that is coupled to (e.g., welded to) the anode tabs AT or the cathode tabs CT at a coupling location (e.g., a weld location). The weld location of the conventional electrochemical cell stack 100 is inside of the stack pouch 114. In some embodiments, the terminals 116 may extend substantially beyond the electrode stack 112 as the terminals 116 may include safety and performance features (e.g., an integrated fuse, etc.). Longer terminals 116 may facilitate coupling to electrical leads of wires. Such longer terminals 116, however, can negatively impact volumetric energy density, i.e., increase the space occupied thereby, which can increase dead volume (i.e., volume occupied by inactive materials) in an assembly including the cell stack 100 which can be undesirable. FIG. 1A shows a side view of the electrode stack 112, detailing the anodes A, the anode current collectors ACC with anode tabs AT, the cathodes C, the cathode current collectors CCC with cathode tabs CT, and the separators 113 stacked together. FIG. 1B shows a top view of the electrode stack 112 with the anode tabs AT and the cathode tabs CT visible and extending from the electrode stack 112. FIG. 1C shows the terminal 116a coupled to the anode tabs AT and the terminal 116b coupled to the cathode tabs CT. As shown in FIG. 1D, the stack pouch 114 effectively creates an excess weld volume W, or an excess of void space created by the incorporation of the electrode stack 112 into the stack pouch 114.

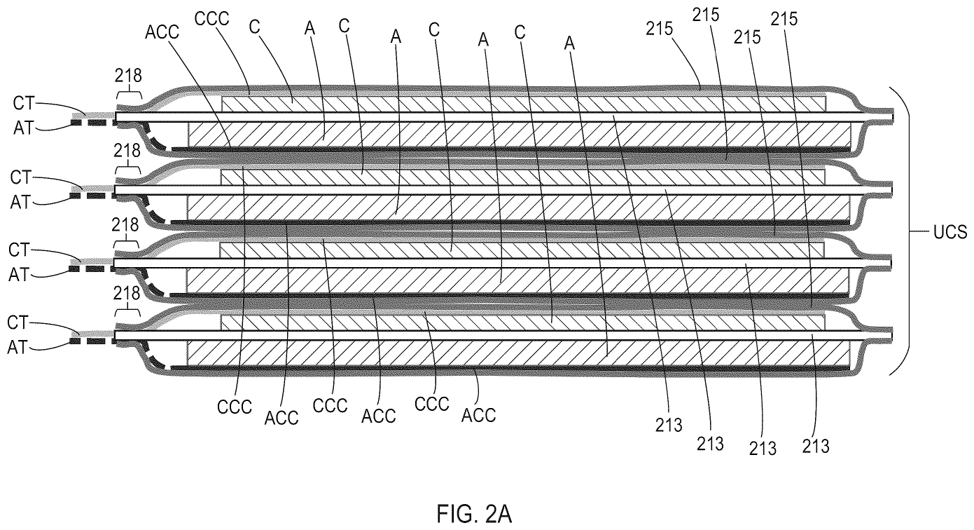

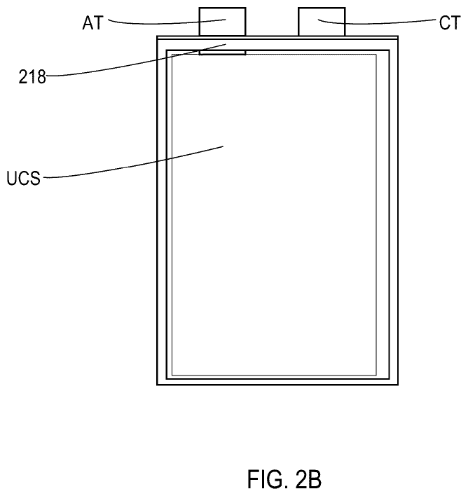

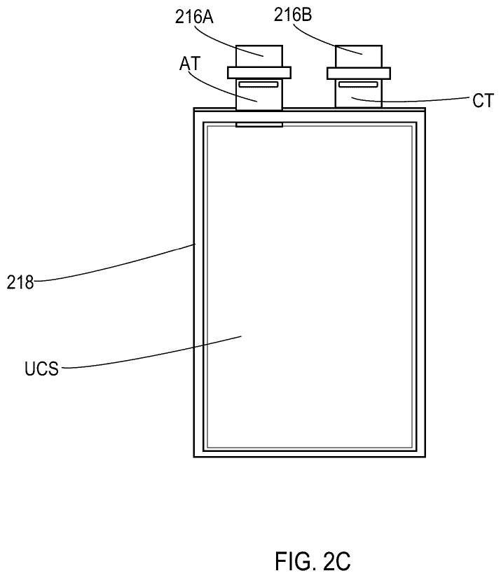

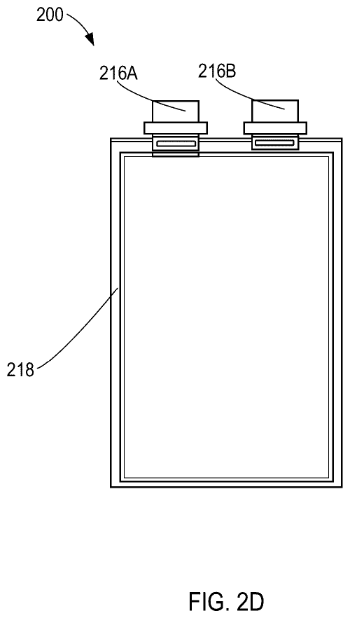

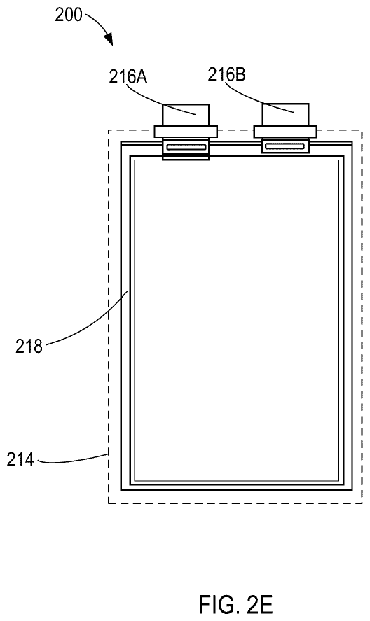

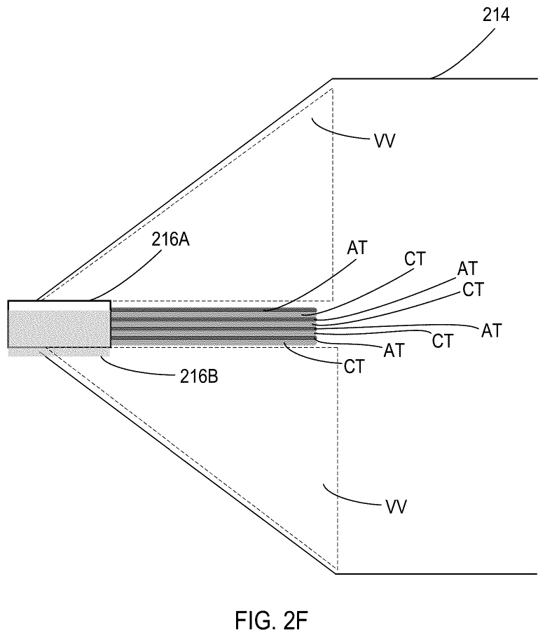

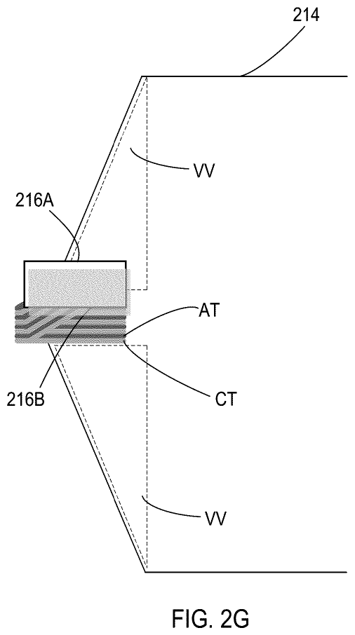

FIGS. 2A-2G are illustrations of a folded electrochemical cell stack 200 with sealing regions 218 and terminals 216a, 216b (collectively referred to as “terminals 216”), which may be folded, according to an embodiment. The folded electrochemical cell stack 200 is functionally similar to the conventional electrochemical cell stack 100. In some embodiments, the folded electrochemical cell stack 200 can include a unit cell stack UCS including one or more semi-solid electrodes. The unit cell stack UCS includes anodes A disposed on corresponding anode current collectors ACC that include anode tabs AT, cathodes C disposed on corresponding cathode current collectors CCC that include cathode tabs CT, and separators 213 disposed between each anode A and each cathode C. Each anode A, anode current collector ACC, cathode C, cathode current collector CCC, and separator 213 collectively form an electrochemical cell or unit cell, and each unit cell is disposed in a unit cell pouch 215. Each unit cell pouch 215 includes the sealing region 218 disposed around its outside edge. The unit cell stack UCS is disposed in a stack pouch 214. The stack pouch 214 may include a void volume VV (e.g., inactive volume, dead space, empty space, etc.).

FIG. 2A shows a side view of the unit cell stack UCS. FIG. 2B shows an overhead view of the unit cell stack UCS with the sealing region 218, the anode tabs AT, and the cathode tabs CT visible. FIG. 2C shows the terminals 216A, 216B extending from the anode tabs AT and the cathode tabs CT, with the terminals 216A, 216B in an unfolded state. In FIG. 2D, the terminals 216 have been folded over a portion of the sealing region 218 of the unit cells. This folding of the terminals 216 over the sealing region 218 reduces the void volume (e.g., inactive volume, dead space, empty space, etc.) in the folded electrochemical cell stack 200, as the excess weld volume (i.e., W from FIG. 1D) no longer adds to the volume of the sealing region 218.

As described herein, each unit cell from the folded electrochemical cell stack 200 includes a sealing region 218 around the perimeter of the unit cell pouch 215. The presence of the unit cell pouches 215 and the sealing region 218 cause the terminals 216 to extend farther away from the center of the electrochemical cells than the terminals 116 extending away from the electrode stack 112 in FIGS. 1A-1D. In other words, the sealing region 218 creates additional volume in an assembly including the electrochemical cell stack 200 that is not occupied by active materials (e.g., anodes A and/or cathodes C), leading to reduced volumetric density (i.e., results in a “volumetric penalty”). The folding of the terminals 216 allows the folded electrochemical cell stack 200 to gain back at least a portion of this volumetric penalty by reducing the volume of the cell assembly occupied by the terminals 216 that do not include any active materials. In some embodiments, the stack pouch 214 can be the same or substantially similar to the stack pouch 114, as described above with reference to FIGS. 1A-1D.

In some embodiments, each of the tabs (e.g., anode tabs AT, cathode tabs CT, also collectively referred to herein as “electrode tabs”) may be electrically coupled to corresponding electrodes and/or corresponding current collectors. For example, in some embodiments, at least one of the anode tabs AT and/or the cathode tabs CT may be electrically coupled to at least one of the anodes A and/or cathodes C, respectively. For example, in some embodiments, anode tabs AT may be electrically coupled to the anodes A, for example, via the anode current collectors ACC. In some embodiments, anode tabs AT may be electrically coupled to the anode current collectors ACC. In some embodiments, the cathode tabs CT may be electrically coupled to the cathodes C, for example, via the cathode current collectors CCC. In some embodiments, the cathode tabs CT may be electrically coupled to the cathode current collectors CCC. In some embodiments, the anode tabs AT may be electrically coupled to form a negative bail (not shown) and/or the cathode tabs CT may be electrically coupled to form a positive bail (not shown).

In some embodiments, the anode tabs AT, the negative bail, the cathode tabs CT, and/or the positive bail may be folded, for example, to reduce the void volume VV in the stack pouch 214. For example, in some embodiments, at least one of the anode tabs AT, the negative bail, the cathode tabs CT, and/or the positive bail may define a folded portion. In some embodiments, the unit cell pouches 215 and/or the stack pouch 214 may each define an internal volume. In some embodiments, each of the electrode tabs (e.g., anode tabs AT, cathode tabs CT) may extend to a region outside the internal volume of the unit cell pouches 215. In some embodiments, the region outside the unit cell pouches 215 may be in the internal volume of the stack pouch 214. In some embodiments, unit cell stack UCS may be disposed in the internal volume of the stack pouch 214. In some embodiments, the electrode tabs (e.g., anode tabs AT, cathode tabs CT) may be coupled to each other, or configured to be coupled to each other, in the region outside the corresponding unit cell pouches 215 (e.g., in the internal volume of the stack pouch 214). In some embodiments, the folded portion of at least one of the anode tabs AT, the negative bail, the cathode tabs CT, and/or the positive bail may be at least partially disposed in the region outside the internal volume of the unit cell pouches 215. In some embodiments, at least a portion of the folded portion of at least one of the anode tabs AT, the negative bail, the cathode tabs CT, and/or the positive bail may be disposed in the internal volume of the stack pouch 214. In some embodiments, at least a portion of the folded portion of at least one of the anode tabs AT, the negative bail, the cathode tabs CT, and/or the positive bail may be disposed outside the internal volume of the stack pouch 214.

In some embodiments, the terminals 216 may include corresponding terminal tabs. In some embodiments, the terminals 216 and/or the terminal tabs may be electrically coupled to the anode tabs AT, the negative bail, cathode tabs CT, and/or the positive bail. In some embodiments, the terminals 216 and/or terminal tabs may be electrically coupled to the electrode tabs (e.g., anode tabs AT, cathode tabs CT) at a coupling location (e.g., coupling point, coupling region, etc.). In some embodiments, the coupling location (e.g., coupling point, coupling region, etc.) may include at least one of a weld or an electrically conductive adhesive. In some embodiments, the coupling location may be at least partially in the internal volume defined by corresponding unit cell pouches 215 and/or in the internal volume of the stack pouch 214. In some embodiments, the terminal tabs and the electrode tabs may form a terminal assembly (not shown). In some embodiments, at least a portion of the terminal assembly may extend, or be disposed, outside the stack pouch 214, for example, outside the internal volume of the stack pouch 214. In some embodiments, at least a portion of the terminals 216 and/or terminal tabs may overlap or envelop, or be configured to overlap or envelop, at least a portion of the electrode tabs (e.g., anode tabs AT, cathode tabs CT).

In some embodiments the sealing region 218 can include heat seals (e.g., sealed via a thermal process). In some embodiments, the sealing region 218 may be mechanical (e.g., fastener, clip, etc.) or chemical (e.g., adhesive, etc.). The terminals 216 may be formed of tabs that extend away from the unit cell stack UCS and can act as extensions coupled (e.g., welded) to anode tabs AT and the cathode tabs CT at weld locations. As shown, the coupling location (e.g., weld location) of the folded electrochemical cell stack 200 is along the sealing region 218. To achieve a coupling location that is collocated with the sealing region 218, the terminals 216 may be folded prior to secondary pouching. Sealing a portion of the terminals 216 in a folded position increases the volumetric energy density of the folded electrochemical cell stack 200 by filling empty space within the folded electrochemical cell stack 200 and bringing the terminals 216 closer to the horizontal center of the unit cell stack UCS.

FIG. 2E shows the stack pouch 214 sealing the area around the terminals 216. FIGS. 2F and 2G show a volumetric comparison of a system without folding the terminals 216, the anode tabs AT, and the cathode tabs CT (FIG. 2F) prior to the sealing of the stack pouch 214 and with the folding of the terminals 216, the anode tabs AT, and the cathode tabs CT (FIG. 2G) prior to the sealing of the stack pouch 214. As shown, including the fold significantly reduces the void volume VV (e.g., by at least about 10%, 20%, 30%, 40%, 50%, or even higher) upon sealing the stack pouch 214.

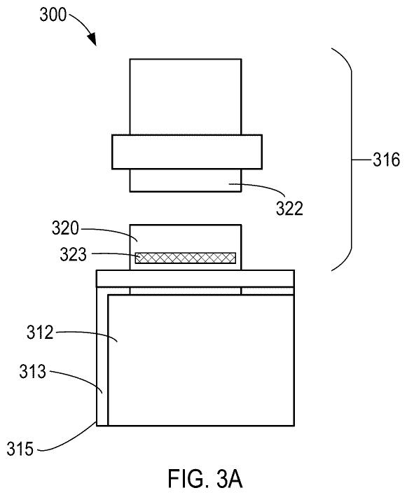

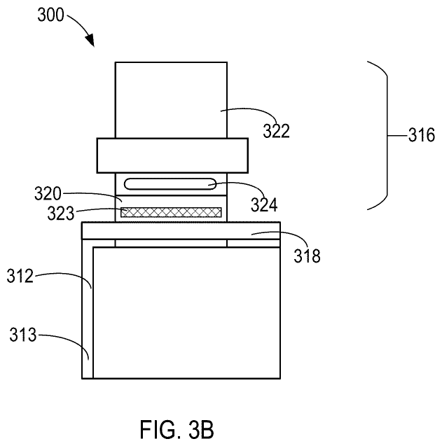

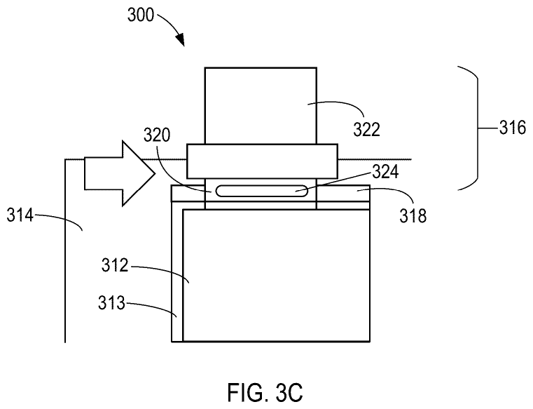

Referring to FIGS. 3A-3C generally, a method of forming and folding an electrochemical cell terminal of an electrochemical cell stack 300 is shown. The electrochemical cell stack 300 includes an electrode stack 312 (which can include a collection of individual unit cells inside unit cell pouches), a separator 313, and a stack pouch 314. FIG. 3A depicts an electrode stack 312 (e.g., functionally and/or structurally similar to the electrode stack 112 of FIGS. 1A-1D or the unit cell stack UCS of FIGS. 2A-2G) with an electrode tab 320 extending away from the electrode stack 312. The electrochemical cell stack 300 also includes a terminal tab 322 that, in FIG. 3A, is not coupled to the electrode tab 320. In some embodiments, the electrode tab 320 and/or the terminal tab 322 may be prepared to be joined (e.g., coupled, interlocked, merged, welded, adhered, fused, etc.). For example, the electrode tab 320 and/or the terminal tab 322 may be coated, pre-treated, scored, and/or have another process applied to prepare the electrode tab 320 and/or the terminal tab 322 for coupling (e.g., glue, weld, adhered, bonded, fused, etc.). In some embodiments, the electrode tab 320 and the terminal tab 322 may be coupled (e.g., joined), for example, at a coupling point, coupling location, or coupling region (e.g., as shown in FIG. 3B). In some embodiments, the electrode tab 320 and the terminal tab 322 may collectively form a terminal assembly 316. As shown, the electrochemical cell stack 300 includes a unit cell pouch 315 and a unit cell seal 318.

In some embodiments, the electrochemical cell stack 300, the electrode stack 312, the separator 313, the stack pouch 314, the unit cell pouch 315, the terminal assembly 316, and the unit cell seal 318 can be similar to, or substantially the same as, the electrochemical cell stack 200, the unit cell stack UCS, the separator 213, the stack pouch 214, the unit cell pouch 215, the terminals 216, and the sealing region 218, respectively, as described herein with respect to FIG. 2. Thus, certain aspects of the electrochemical cell stack 300, the electrode stack 312, the separator 313, the stack pouch 314, the unit cell pouch 315, the terminal assembly 316, and the unit cell seal 318 are not described in greater detail herein.

FIG. 3B depicts the electrode tab 320 coupled to the terminal tab 322 at a coupling point 324. The electrode tab 320 may overlap and be coupled to the terminal tab 322, for example, via a weld, electrically conductive adhesive, or other method of coupling that allows for electrical current to flow between the electrode tab 320 to the terminal tab 322. The coupling point 324, in FIG. 3B, is located outside of the unit cell seal 318. The unit cell seal 318 is the sealing edge of a plurality of unit cell pouches 315 around the electrode stack 312. Including the coupling point 324 extending past the unit cell seal 318 decreases the volumetric energy density of the electrochemical cell stack 300.

To increase the volumetric energy density of the electrochemical cell stack 300, the electrode tab 320 and/or the terminal tab 322 is folded, in FIG. 3C, so that the coupling point 324 overlaps with the unit cell seal 318. The unit cell seal 318 is sealed prior to folding and can be compressed by the electrode tab 320 and/or the terminal tab 322 during folding. The compression of the unit cell pouches 315 can reduce the overall volume of the electrochemical cell stack 300 and improve volumetric energy density and packing efficiency by overlapping the coupling point 324 and the unit cell seal 318. FIG. 3C also depicts a stack pouch 314 (e.g., structurally and/or functionally similar to the stack pouch 114 of FIGS. 1A-1D) sealing in the electrode stack 312. In some embodiments, the terminal tab 322 is sealed to the stack pouch 314.

In some embodiments, the electrochemical cell stack 300 may include a plurality of electrode tabs extending from the unit cell stack, each of which may be similar to, or substantially the same as the electrode tab 320. The plurality of electrode tabs may be collectively referred to as “electrode tabs 320”. In some embodiments, the electrode tabs 320 may be coupled, for example, in a bail. In some embodiments, the electrode tabs 320 may optionally include a coupling point, region, or location, for example, a weld 323. In some embodiments, the weld 323 may be configured to couple the electrode tabs 320, for example, prior to joining the electrode tabs 320 to the terminal tab 322 (or vice versa) (e.g., as shown in FIG. 3A). In other words, the weld 323 may include a pre-weld that is used to couple the electrode tabs 320 in a bail, prior to folding of the electrode tabs 320, as described herein.

The weld 323 may be incorporated in the electrode tabs 320 proximate to the unit cell seal 318. In some embodiments, the weld 323 may be incorporated in the electrode tabs 320 external to the unit cell seal 318. Including the weld 323 in the electrode tabs 320 may, for example, enable the electrode tabs 320 to remain combined, coupled, or joined together and/or retain consistent geometry while forming the electrochemical cell stack 300 and/or folding the electrode tabs 320. In some embodiments, the weld 323 may facilitate bending of the electrode tabs 320, for example, by providing a hinge point in the electrode tabs 320. Incorporating the weld 323 in the electrode tabs 320, for example, prior to coupling the electrode tabs 320 to the terminal tab 322, may facilitate ease of manufacturing, forming, and/or bending of the electrochemical cell stack 300. Likewise, the weld 323 in the electrode tabs 320 may further reduce inactive space and/or increase volumetric energy density of the electrochemical cell stack 300, for example, by improving packing efficiency in the electrochemical cell stack 300.

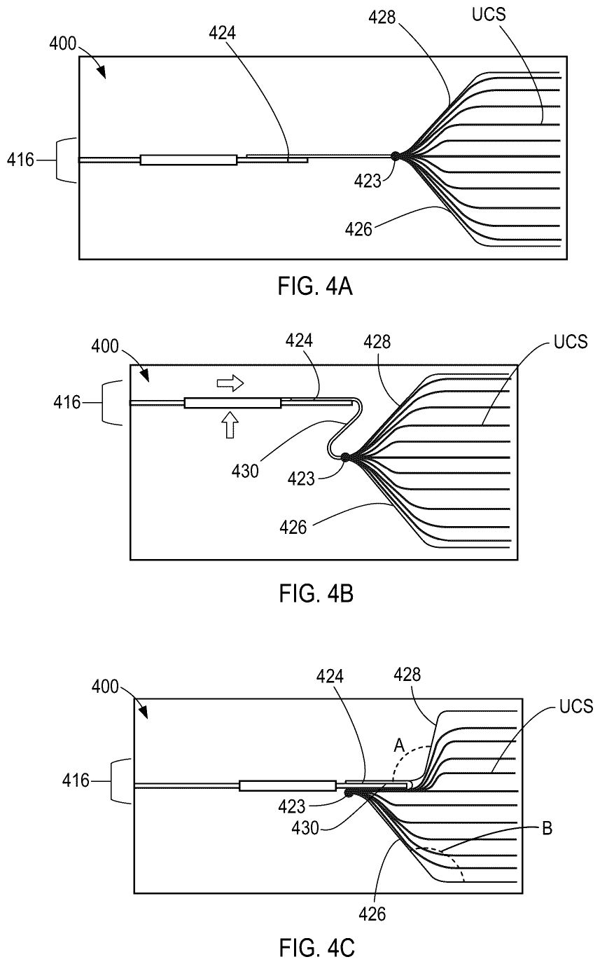

FIGS. 4A-4C depict a side view of a method of folding an electrochemical cell terminal assembly 416 of an electrochemical cell stack 400 including a plurality of unit cells stacked together (labeled as a unit cell stack UCS), according to an embodiment. In FIG. 4A, the electrochemical cell terminal assembly 416 (e.g., functionally and/or structurally similar to one of the terminals 216 of FIG. 2A-2G, and/or the terminal assembly 316 of FIG. 3A-3C) is not folded and includes a coupling point 424 (e.g., a coupling location or region) at which one or more electrode tabs couple to a terminal tab (e.g., functionally and/or structurally similar to the terminal tab 322 of FIG. 3A-3C). The electrochemical cell terminal assembly 416 extends away from a bottom edge 426 and a top edge 428. In some embodiments, the electrochemical cell stack 400 may optionally include a weld 423 (e.g., a weld formed prior to folding of the one or more electrode tabs, as described herein).

In some embodiments, the electrochemical cell stack 400 may include a plurality of electrode tabs (not shown) extending from the unit cell stack UCS. Each of the plurality of electrode tabs may extend from a corresponding electrode and/or cell in the unit cell stack UCS. In some embodiments, each of the plurality of electrode tabs may be similar to, or substantially the same as, the anode tabs AT and/or the cathode tabs CT as described with respect to FIG. 2A-2G, or the electrode tab 320 as described with respect to FIG. 3, and may be collectively referred to as “electrode tabs”. In some embodiments, each of the electrode tabs may extend from, or be electrically coupled to, a corresponding anode, and, hence, may be a negative electrode tab (e.g., anode tab AT). In some embodiments, each of the electrode tabs may extend from, or be electrically coupled to, a corresponding cathode, and hence, may be a positive electrode tab (e.g., cathode tab CT). In some embodiments, the electrode tabs may be coupled (e.g., joined, welded, fused, bonded, adhered, electrically coupled, etc.), for example, in a bail. In some embodiments, the electrode tabs may include anode tabs coupled in a negative bail. In some embodiments, the electrode tabs may include cathode tabs coupled in a positive bail.

In some embodiments, the electrochemical cell terminal assembly 416 may optionally include the weld 423. In some embodiments, the weld 423 may be incorporated in the electrode tabs. In some embodiments, the weld 423 may be configured to couple the electrode tabs, for example, prior to joining the electrode tabs to the terminal tab (or vice versa) (e.g., as shown in FIG. 4A). The weld 423 may be incorporated in the electrode tabs proximate an exterior of the unit cell stack UCS. In some embodiments, the weld 423 may be incorporated in the electrode tabs external to the unit cell stack UCS, for example, proximate but external to a meeting point of the bottom edge 426 and the top edge 428. Including the weld 423 in the electrode tabs and/or the electrochemical cell terminal assembly 416, may, for example, enable the electrode tabs to remain together (e.g., coupled, joined, electrically coupled) and/or retain consistent geometry while folding electrode tabs. In some embodiments, the weld 423 may facilitate bending of the electrode tabs and/or the electrochemical cell terminal assembly 416, for example, by providing a hinge point in the electrode tabs and/or the electrochemical cell terminal assembly 416. Incorporating the weld 423 in the electrode tabs and/or the electrochemical cell terminal assembly 416, for example, prior to coupling the electrode tabs to the terminal tab, may facilitate ease of manufacturing, forming, and/or bending of the electrochemical cell stack 400 and/or the electrochemical cell terminal assembly 416. Likewise, the weld 423 in the electrode tabs and/or the electrochemical cell terminal assembly 416 may further reduce inactive space and/or increase volumetric energy density of the electrochemical cell stack 400, for example, by improving packing efficiency of the electrochemical cell stack 400, as described herein.

In FIG. 4B, the electrochemical cell terminal assembly 416 is manipulated via movement upward (e.g., vertically away from the bottom edge 426) and forward (e.g., horizontally toward the top edge 428). The electrochemical cell terminal assembly 416 forms a z-shaped section 430 (e.g., folded portion, for example, folded in the shape of the letter “Z”). In some embodiments, the z-shaped section 430 (i.e., folded portion) may include a first portion, a second portion substantially parallel to the first portion, and a third portion coupled to the first portion and the second portion. In some embodiments, the third portion may be inclined at an angle with respect to the first and second portions. In some embodiments, the first and second portions may include, or be, two horizontal portions connected via the third portion. In some embodiments, the third portion may include, or be, a diagonal portion.

In some embodiments, the first and second portions (e.g., horizontal portions) may have a vertical distance and/or horizontal distance therebetween, for example, between surfaces and/or edges thereof. In some embodiments, the z-shaped section 430 (i.e., folded portion) may be collapsed, or may be configured to collapse, for example, to reduce the vertical distance between horizontal portions. For example, in some embodiments, the third portion (e.g., diagonal portion) may be configured to be disposed horizontally between (i.e., interposed between) the first and second portions (e.g., two horizontal portions). For example, in some embodiments, the z-shaped portion 430 (i.e., folded portion) includes the first portion, the second portion, and the third portion between the first and second portions, each of the first, second, and third portions being substantially parallel to each other. In some embodiments, the first portion, the second portion, and/or the third portion may each include a first side (e.g., first surface) and a second side (e.g., second surface). The second side of each of the first portion, the second portion, and/or the third portion may be opposite the first side of each corresponding first portion, second portion, and/or third portion. In some embodiments, the first side of the third portion may be in contact with a corresponding side of the first portion, and the second side of the third portion opposite the first side is in contact with a corresponding side of the second portion. The vertical and/or horizontal distances (e.g., collectively referred to as “distances”) that the electrochemical cell terminal assembly 416 is manipulated upward and/or forward may correspond to a desired shape and/or size of the z-shaped section.

In some embodiments, the distances may be related to a thickness of a cell stack (e.g., unit cell stack UCS) in the electrochemical cell stack 400. In some embodiments, the distances are at least about 1%, at least about 2%, at least about 3%, at least about 4%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% of the thickness of the cell stack (e.g., unit cell stack UCS). In some embodiments, the distances are no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, no more than about 10%, no more than about 5%, no more than about 4%, no more than about 3%, no more than about 2%, or no more than about 1% of the thickness of the cell stack (e.g., unit cell stack UCS).

Combinations of the above-referenced proportions of distances to thicknesses of the cell stack (e.g., unit cell stack UCS) are also possible (e.g., at least about 1% and no more than about 100% or at least about 5% and no more than 15%), inclusive of all values and ranges therebetween. In some embodiments, the distances are about 1%, about 2%, about 3%, about 4%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of the thickness of the cell stack.

In some embodiments, the electrochemical cell terminal assembly 416 may be manipulated to form additional bends to form an accordion-shaped electrochemical cell terminal assembly 416, depending on the length of the electrochemical cell terminal assembly 416 and the desired configuration. In some embodiments, the electrochemical cell terminal assembly 416 is manipulated to form at least one bend, at least two bends, at least three bends, at least four bends, or at least five bends. In some embodiments, the electrochemical cell terminal assembly 416 is manipulated to form no more than five bends, no more than four bends, no more than three bends, no more than two bends, or no more than one bend. Combinations of the above-referenced numbers of bends of the electrochemical cell terminal assembly 416 are also possible (e.g., at least two bends and no more than five bends), inclusive of all values and ranges therebetween. In some embodiments, the electrochemical cell terminal assembly 416 is manipulated to form one bend, two bends, three bends, four bends, or five bends.

In FIG. 4C, the electrochemical cell terminal assembly 416 is manipulated down (e.g., vertically toward the bottom edge 426) and flattened into the top edge 428. The top edge 428 is flattened (e.g., folded down) due to the cell terminal assembly 416 folded into the top edge 426. In some embodiments, the top edge 326 may include pre-folded areas that aid in flattening. The z-shaped section 430 forms a terminal stack that may be sealed into place when the electrochemical cell stack 400 is sealed. In some embodiments, the process shown in FIGS. 4A-4C can be applied to a single cell stack or a collection of multiple cell stacks.

The z-shaped section 430 and the top edge 428 form an angle A. In some embodiments, the angle A may be an obtuse angle. In some embodiments, the angle A can be at least about 90 degrees, at least about 91 degrees, at least about 92 degrees, at least about 93 degrees, at least about 94 degrees, at least about 95 degrees, at least about 100 degrees, at least about 105 degrees, at least about 110 degrees, at least about 115 degrees, at least about 120 degrees, at least about 130 degrees, at least about 140 degrees, or at least about 150 degrees. In some embodiments, the angle A can be no more than about 150 degrees, no more than about 140 degrees, no more than about 130 degrees, no more than about 120 degrees, no more than about 115 degrees, no more than about 110 degrees, no more than about 105 degrees, no more than about 100 degrees, no more than about 95 degrees, no more than about 94 degrees, no more than about 93 degrees, no more than about 92 degrees, no more than about 91 degrees, or no more than about 90 degrees.

Combinations of the above-referenced angles are also possible (e.g., at least about 90 degrees and no more than about 130 degrees, or at least about 100 degrees and no more than about 150 degrees), inclusive of all values and ranges therebetween. In some embodiments, the angle A can be about 90 degrees, about 91 degrees, about 92 degrees, about 93 degrees, about 94 degrees, about 95 degrees, about 100 degrees, about 105 degrees, about 110 degrees, about 115 degrees, about 120 degrees, about 130 degrees, about 140 degrees, or about 150 degrees.

In some embodiments, the angle A is less than an angle B, formed by the bottom edge 426 with the bottom surface of the electrochemical cell stack 400. In some embodiments, the angle A is less than the angle B. In some embodiments, the ratio between angle A and angle B is at least about 60% (e.g., angle A is 60% of angle B), at least about 61%, at least about 62%, at least about 63%, at least about 64%, at least about 65%, at least about 70%, at least about 75%, at least about 80%, at least about 85%, at least about 90%, at least about 95%, or at least about 99%. In some embodiments, the ratio between angle A and angle B is no more than about 99%, no more than about 95%, no more than about 90%, no more than about 85%, no more than about 80%, no more than about 75%, no more than about 70%, no more than about 65%, no more than about 64%, no more than about 63%, no more than about 62%, no more than about 61%, or no more than about 60%.

Combinations of the above-references angle ratios are also possible (e.g., at least about 60% and no more than about 99% or at least about 80% and no more than about 90%), inclusive of all values and ranges therebetween. In some embodiments, the ratio between angle A and angle B may be about 60%, about 61%, about 62%, about 63%, about 64%, about 65%, about 70%, about 75%, about 80%, about 85%, about 90%, about 95%, about 99%.

In some embodiments, the electrochemical cell stack 400 and the terminal assembly 416 can be similar to, or substantially the same as, the electrochemical cell stack 200 and the terminal 216 as described herein with respect to FIGS. 2A-2G. Thus, certain aspects of the electrochemical cell stack 400 and the terminal assembly 416 are not described in greater detail herein.

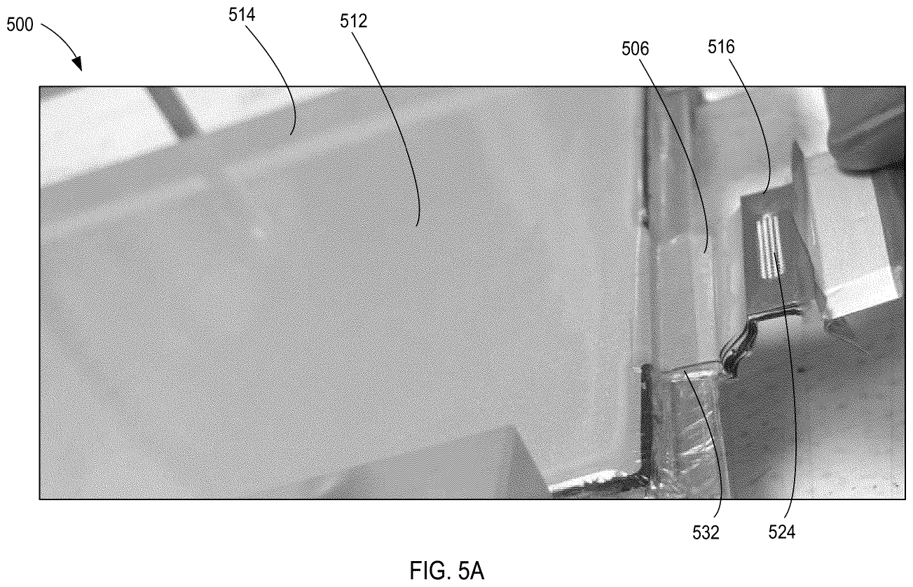

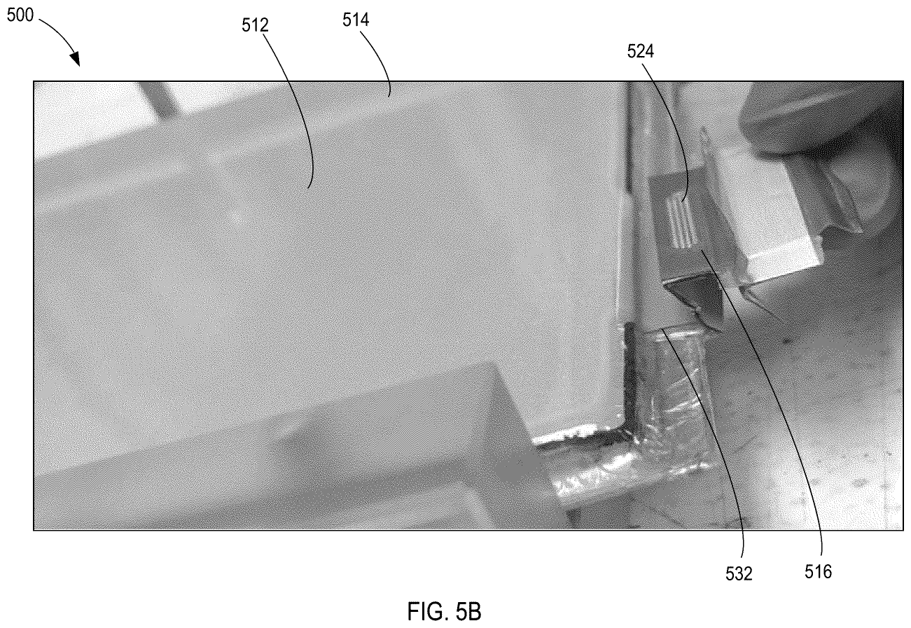

FIGS. 5A-5B depict a perspective view of a method of folding a terminal 516 (e.g., functionally and/or structurally similar to the terminal 216 of FIGS. 2A-2G) of an electrochemical cell stack 500 (e.g., functionally and/or structurally similar to the folded electrochemical cell stack 200 of FIGS. 2A-2G), according to an embodiment. As shown, the electrochemical cell terminal 516 is manipulated by hand but, in some embodiments, may be manipulated by a machine, device, or the like. In FIG. 5A, the electrochemical cell terminal 516 extends away from an electrode stack 512 and extends past a pouch edge 532 such that a coupling point 524 (e.g., a coupling location or region) of the electrochemical cell terminal 516 is located beyond the pouch edge 532. FIG. 5B depicts the electrochemical cell terminal 516 being manipulated (e.g., folded or urged) into a z-shape (e.g., similar to FIG. 4C) such that the coupling point 524 is moved toward the pouch edge 532. In some embodiments, the electrochemical cell terminal 516 may be further manipulated such that the coupling point 524 is pushed into the pouch edge 532.

In some embodiments, the electrochemical cell stack 500, the electrode stack 512, the separator 513, the stack pouch 514, and the terminal 516 can be similar to, or substantially the same as, the electrochemical cell stack 200, the unit cell stack UCS, the separator 213, the pouch 214, and the terminal 216, as described above with respect to FIGS. 2A-2G. Thus, certain aspects of the electrochemical cell stack 500, the electrode stack 512, the separator 513, the stack pouch 514, and the terminal 516 are not described in greater detail herein.

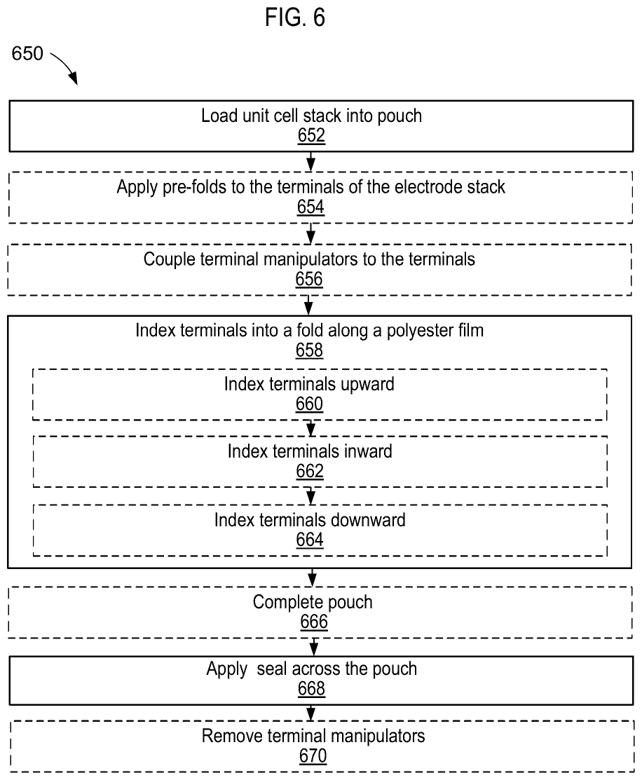

FIG. 6 is a block diagram of a method 650 of preparing and sealing an electrochemical cell, according to an embodiment. The method 650 forms an electrochemical cell stack (e.g., functionally and/or structurally similar to the folded electrochemical cell stack 200 of FIGS. 2A-2G) that has a volumetric energy density equal to or greater than the volumetric energy density of a conventional electrochemical cell, such as the conventional electrochemical cell stack 100 of FIGS. 1A-1D. As shown, the method 650 includes loading a unit cell stack into a stack pouch at step 652. The electrode stack can include a collection of unit cells each disposed in a unit cell pouch. The method 650 optionally includes applying pre-folds to terminals of the electrode stack at step 654 and coupling terminal manipulators to the terminals at step 656. The method 650 further includes indexing terminals into a fold along each unit cell pouch at step 658. This can optionally include indexing the terminals upward at step 660, indexing the terminals inward at step 662, and/or indexing the terminals downward at step 664. The method 650 optionally includes completing the stack pouch at step 666. The method 650 further includes applying a seal across the stack pouch at step 668. The method 650 optionally includes removing the terminal manipulators at step 670.

At step 652, a unit cell stack is loaded into a stack pouch. In some embodiments, the stack pouch may be an aluminized pouch. In some embodiments, the stack pouch may be a pouch half. In some embodiments, the unit cell stack may be inserted into an open stack pouch. The unit cell stack includes two terminals (e.g., a positive terminal and a negative terminal) extending away from the unit cell. In some embodiments, the unit cell stack may have one terminal or more than two terminals. The unit cell stack is loaded into the pouch such that the at least one terminal extends beyond the pouch. Additionally, the unit cell stack can be sealed in a pouch (e.g., laminate polyester film).

At step 654, pre-folds are optionally applied to the terminals, for example, to create fold lines in the terminals about which the terminals can be folded. In some embodiments, the pre-folds are applied by an angled punch. The location of the pre-folds corresponds to the locations of the folds in the final position of the terminals. For example, if the final position of the terminals is a z-shape, there may be two pre-folds formed that correspond to the corners of the z-shape. Applying pre-folds may simplify the tooling used during the folding process as the terminals may form easier after pre-folding. In some embodiments, step 654 may be optional.

At step 656, terminal manipulators are optionally coupled to the terminals. The terminal manipulators control the movement of the terminals. In some embodiments, the terminal manipulators may be clamped, adhered, welded, press fit, or the like to the terminals. In some embodiments, the terminal manipulators are formed of multiple parts that may be coupled around the terminals. In some embodiments, the terminal manipulators may be coupled to a device (e.g., robotic device, jig, etc.) that facilitates folding the terminals. In some embodiments, one terminal manipulator may be coupled to multiple terminals. In some embodiments, each terminal is coupled to a corresponding terminal manipulator. In some embodiments, step 656 may be optional. For example, the terminals may be folded by hand without the need for terminal manipulators.

At step 658, the terminals are indexed into a fold along the pouch, portion of a pouch, or a film included in a pouch. In some embodiments, the terminals are indexed via the terminal manipulators. In some embodiments, the terminals are indexed such that a coupling point (e.g., weld point, adhesion point, etc.) of the terminal overlaps with an edge of the pouch (e.g., a sealing region of the pouch). In some embodiments, the terminals are indexed such that the terminals form a z-shape. In some embodiments, the terminals are indexed such that the terminals form an accordion shape.

Referring generally to the indexing steps 660, 662, and 664, the steps describe optionally forming a z-shaped terminal fold. The method 650 may include different indexing steps to form terminals with shapes other than the z-shaped terminal fold described herein. At step 660, the terminals are indexed upward away from a bottom edge of the pouch. The terminals are then indexed inward toward the pouch at step 662. After step 662, the terminals are in a general z-shape. Once in a z-shape, the terminals, at 664, are indexed down such that the terminals are level with the mid-plane of the electrode stack. In some embodiments, such as when terminals are folded multiple times, step 658 may be repeated multiple times. For example, step 658 may be repeated at least one time, at least two times, at least three times, or at least four times. In some embodiments, steps 658 may be repeated no more than four times, no more than three times, no more than two times, or no more than one time.

Combinations of the above-referenced repetitions are also possible (e.g., at least two times and no more than four times), inclusive of all values and ranges therebetween. In some embodiments, step 658 is repeated one time, two times, three times, or four times.

At step 666, the pouch is optionally completed. For example, a top half of the stack pouch (e.g., a sheet or film of pouch material such as a polyester film) may be stacked on top of the electrode stack. In some embodiments, step 666 is optional. For example, if the electrode stack at step 652, was loaded into an open, complete pouch, the stack pouch may not need for the pouch to be completed. At step 668, a seal is applied to seal the stack pouch. The seal is applied along the edge of the stack pouch to seal the fold of the terminals, formed in step 658, to secure the terminals in the folded position inside the stack pouch and on the polyester film. In some embodiments, the seal is formed thermally (e.g., heat seal), mechanically (e.g., clip, fastener, etc.), chemically (e.g., adhesive, etc.), or some combination thereof. At step 670, the terminal manipulators are removed from the terminals. In some embodiments, such as those where a terminal manipulator is not used, step 670 is optional.

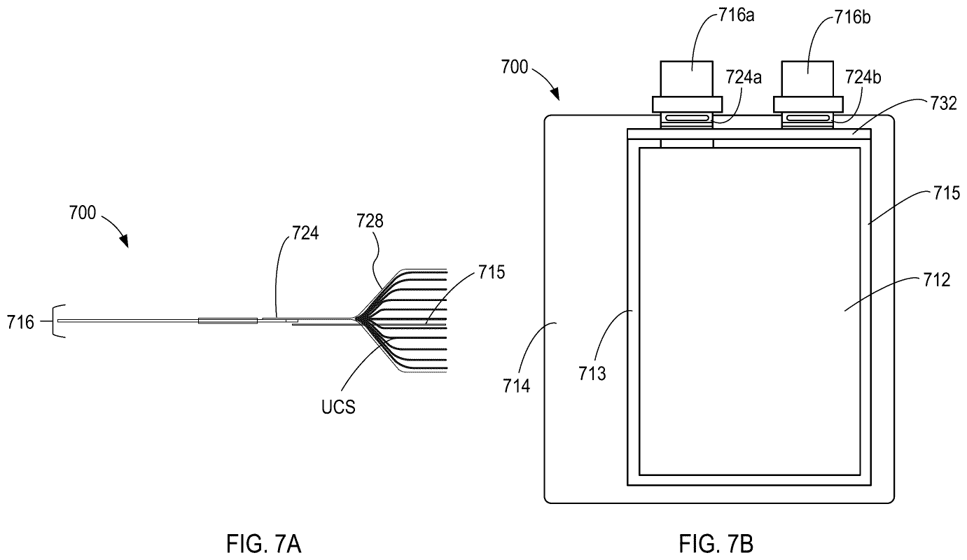

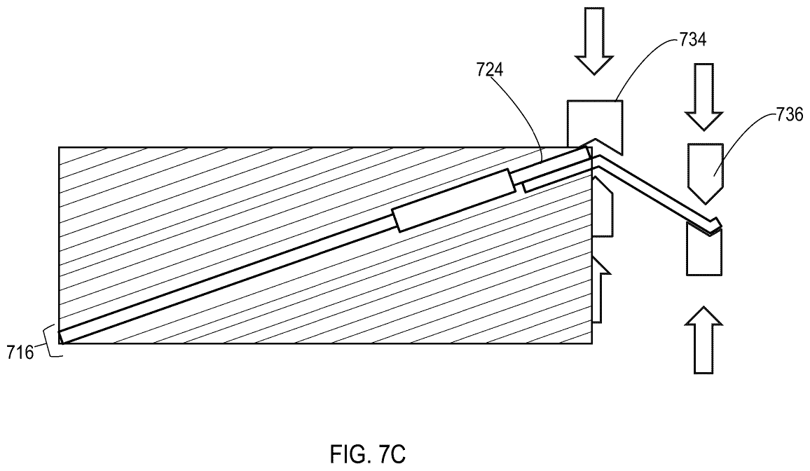

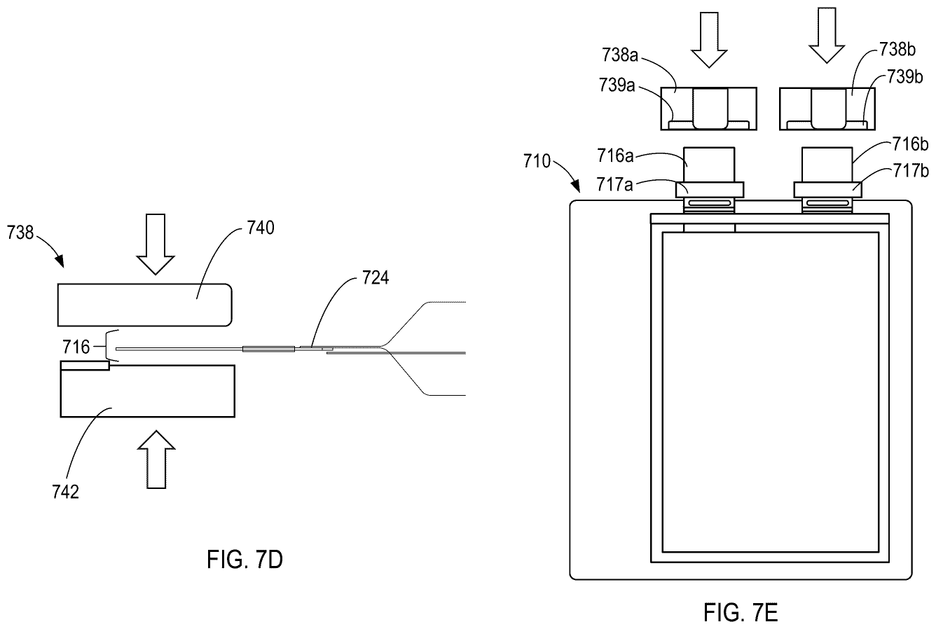

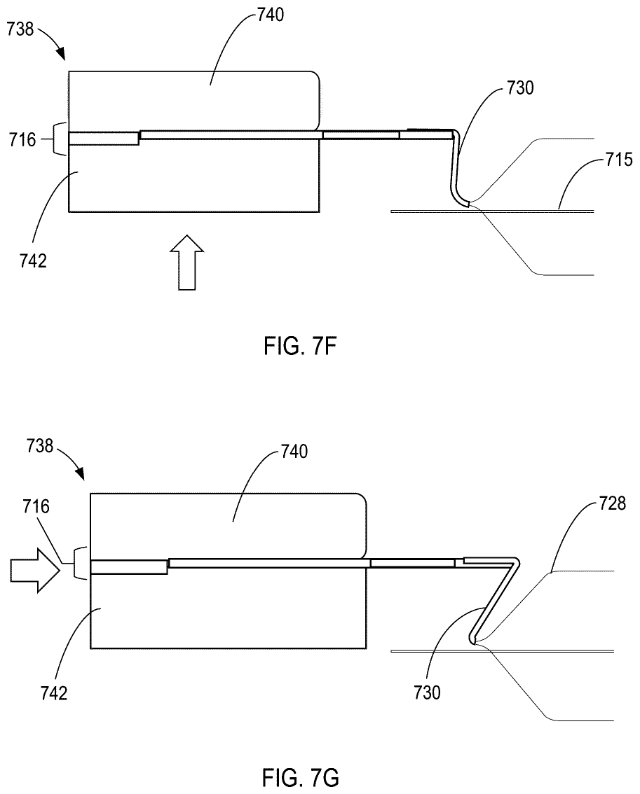

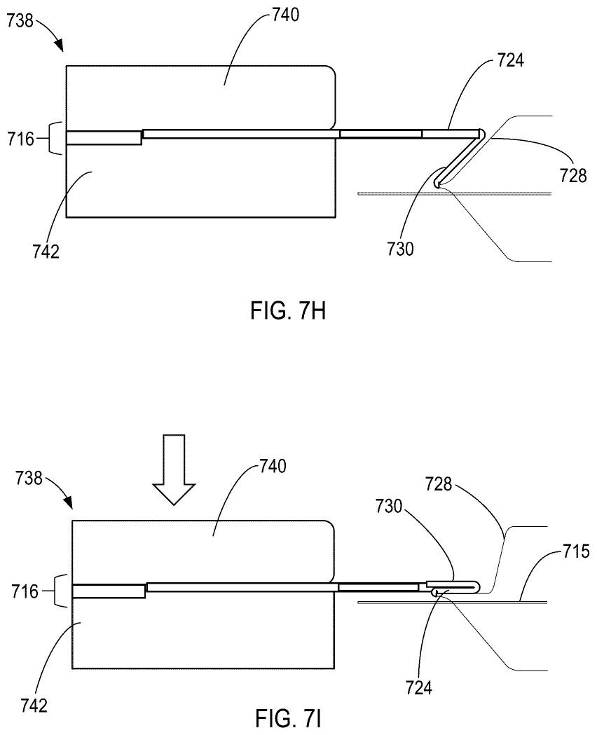

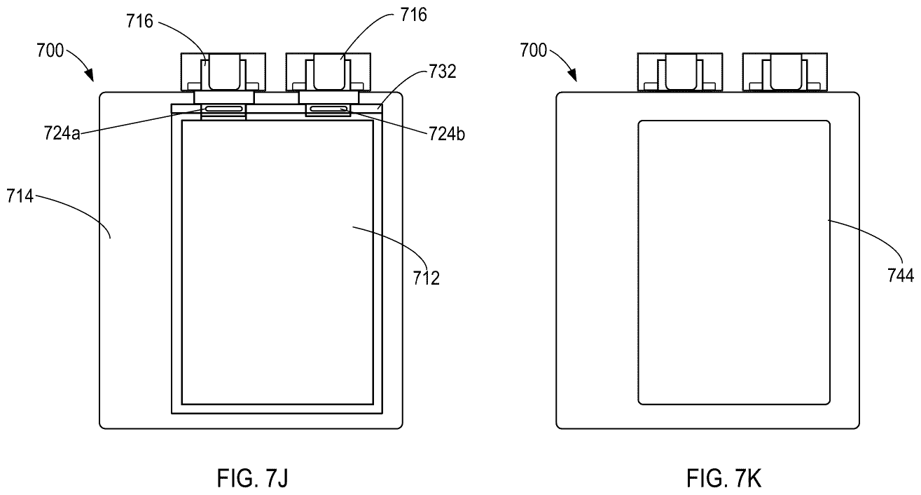

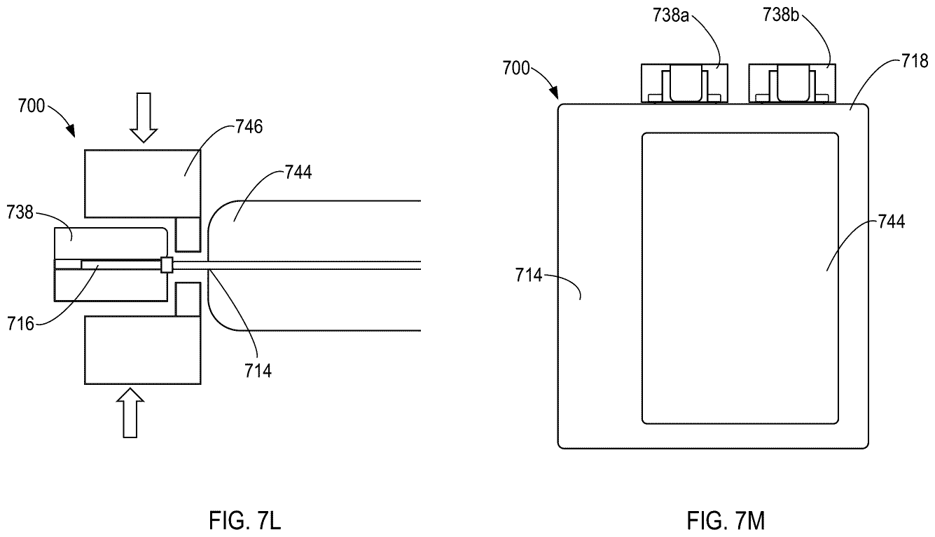

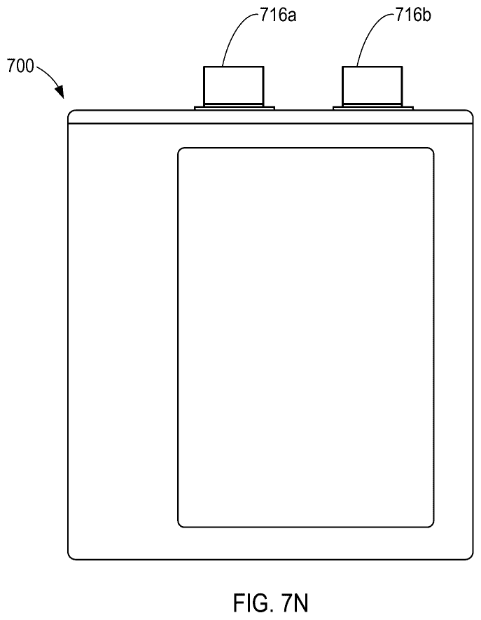

Referring generally to FIGS. 7A-7N, the steps of a method of preparing, folding, and sealing cell terminals into stack pouch 714 to form an electrochemical cell stack 700 are depicted. As shown, the electrochemical cell stack 700 includes a plurality of unit cells stacked together (labeled as a unit cell stack UCS). The method depicted in FIGS. 7A-7N is similar to the method 650 described in reference to FIG. 6. The method depicted in FIGS. 7A-7N includes forming terminals 716a, 716b (collectively referred to as terminals 716) into a z-shaped fold (such that electrode tabs, i.e., anode tabs and cathode tabs are folded into a z-shape), but other shaped folds may be possible. For example, an accordion shape may be formed. In some embodiments, the terminals 716 are electrode terminals.

FIG. 7A depicts a side view of an electrochemical cell stack 700 (e.g., functionally and/or structurally similar to the folded electrochemical cell stack 200 of FIGS. 2A-2G), according to an embodiment. FIG. 7A generally corresponds to the result of step 652 of method 650, as described above with reference to FIG. 6. Each unit cell in the electrochemical cell stack 700 includes a unit cell pouch 715, a terminal 716 and coupling points 724 (e.g., coupling point 724a and coupling point 724b). As seen in FIG. 7B, a top view of the electrochemical cell stack 700, the electrochemical cell stack 700 includes an electrode stack 712, from which the terminals 716 extend. The terminals 716 extend past a top edge 732. The electrode stack 712 is inserted within a stack pouch 714.

FIG. 7C depicts the terminal 716 being pre-folded using an angled punch, according to an embodiment. FIG. 7C generally corresponds to step 654 of method 650 of FIG. 6. The angled punch includes a first punch 734 that forms a first kink in the terminal 716 at a first location and a second punch 736 that forms a second kink in the terminal 716 at a second location. Pre-folding the terminal 716 may allow for easier folding and may guide the terminals during indexing. In some embodiments, pre-folding the terminal 716 may be optional. While FIG. 7C depicts pre-folding one terminal 716, all terminals 716 may be pre-folded. In some embodiments, additional punches may be used to form additional pre-folds in the terminal 716.

FIG. 7D depicts coupling terminal manipulators 738 to the terminals 716, according to an embodiment. FIG. 7D generally corresponds to step 656 of method 650 of FIG. 6. The terminal manipulators 738 couple to the terminals 716 via a first half 740 and a second half 743 of a terminal manipulator 738 squeezing together on the terminal 716. FIG. 7E depicts a top view of the terminal manipulators 738 coupling to the terminals 716. In the depicted embodiment, each terminal 716 has a corresponding terminal manipulator 738. In some embodiments, a terminal manipulator 738 may couple to multiple terminals 716. In some embodiments, the terminal manipulators 738 are portions of a folding system (e.g., robotic system, etc.) which can include additional components to automatically, or through the use of user input, create folds. FIG. 7E also depicts indexing points 739 (including 739a and 739b) on the terminal manipulators 738. The indexing points 739 are configured to index against tab sealing tape 717 (including 717a and 717b) on the terminals 716. In some embodiments, the terminal manipulators 738 index against the metallic portion of the terminals 716.

FIGS. 7F-7I generally correspond to steps 658-664 of method 650 of FIG. 6. FIG. 7F depicts a terminal manipulator indexing the terminal 716 upward away from the unit cell pouch 715. The terminal manipulator 738 is indexed such that a folded portion 730 (including the terminal 716 and the electrode tabs) extends vertically away from the unit cell pouch 715. FIG. 7G depicts a terminal manipulator 738 indexing the terminal 716 toward the top edge 728. The terminal manipulator 716 is indexed such that the folded portion 730 is moved into the top edge 728 such that the folded portion 730 forms a z-shape. FIG. 7H depicts the coupling point 724 located above the top edge 728.

Once the coupling point 724 is located as in FIG. 7H, the terminal manipulators 738 index the terminal 716 down into the unit cell pouch 715, as shown in FIG. 7I. The terminal 716 is pushed down into the unit cell pouch 715 such that the folded portion 730 and the coupling point 724 is located flat against the unit cell pouch 715. In some embodiments, the horizontal length of the folded portion 730 is at least about 0.1 mm, at least about 0.2 mm, at least about 0.3 mm, at least about 0.4 mm, at least about 0.5, at least about 1 mm, at least about 1.5 mm, at least about 2 mm, at least about 2.5 mm, at least about 3 mm, at least about 4 mm, at least about 5 mm, at least about 6 mm, at least about 7 mm, at least about 8 mm, at least about 9 mm, at least about 1 cm. In some embodiments, the distance the folded portion 730 overlaps the pouch is no more than about 1 cm, no more than about 9 mm, no more than about 8 mm, no more than about 7 mm, no more than about 6 mm, no more than about 5 mm, no more than about 4 mm, no more than about 3 mm, no more than about 2.5 mm, no more than about 2 mm, no more than about 1.5 mm, no more than about 1 mm, no more than about 0.5 mm, no more than about 0.4 mm, no more than about 0.3 mm, no more than about 0.2 mm, no more than about 0.1 mm.

Combinations of the above-referenced distances are also possible (e.g., at least 0.1 mm and no more than 1 cm or at least 0.5 mm and no more than 3 mm, inclusive of all values and ranges therebetween). In some embodiments, the distance the folded portion 730 overlaps the unit cell pouch 715 is about 0.1 mm, about 0.2 mm, about 0.3 mm, about 0.4 mm, about 0.5 mm, about 1 mm, about 1.5 mm, about 2 mm, about 2.5 mm, about 3 mm, about 4 mm, about 5 mm, about 6 mm, about 7 mm, about 8 mm, about 9 mm, about 1 cm.

FIG. 7J depicts a top view of the coupling points 724 of the folded terminals 716 overlapping the top edge 732 according to an embodiment. FIG. 7K depicts a stack pouch top half 744 applied to the electrochemical cell 710, according to an embodiment. FIG. 7K generally corresponds to step 666 of method 650 of FIG. 6.

FIG. 7L depicts a side view of a heat sealer 746 sealing the electrochemical cell stack 700. The heat sealer presses down the stack pouch top half 744 into the stack pouch 714. The heat sealer 746 seals the folded portion 730 of the terminals 716 into the stack pouch 714. FIG. 7M depicts a heat seal 718 formed on the top edge of the stack pouch 714. In some embodiments, the heat seal 718 may only cover a portion of the edge of the stack pouch 714. For example, the heat seal 718 may only appear at the location of the terminals.

Sealing the folded portion 730 of the terminal 716 into the stack pouch 714 allows for excess volume of the terminal 716 to be stored within the stack pouch 714, thus increasing the volumetric energy density of the electrochemical cell 710. FIGS. 7K-7M generally correspond to step 668 of method 650 of FIG. 6. Once the electrochemical cell stack 700 is sealed, the terminal manipulators 738 are removed, as shown in FIG. 7N.

In some embodiments, the electrochemical cell stack 700, the electrode stack 712, the separator 713, the stack pouch 714, the terminal 716, and the seal 718 can be the same or substantially similar to the electrochemical cell stack 200, the unit cell stack UCS, the separator 213, the stack pouch 214, the terminal 216, and the sealing region 218, as described above with respect to FIGS. 2A-2G. Thus, certain aspects of the electrochemical cell stack 700, the electrode stack 712, the separator 713, the stack pouch 714, the terminal 716, and the seal 718 are not described in greater detail herein.

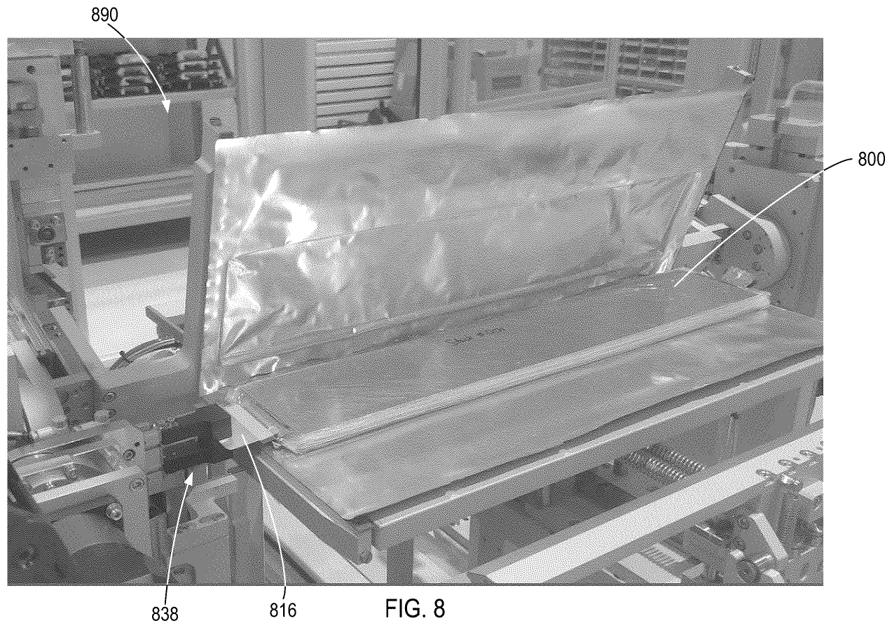

FIG. 8 is as photograph of an electrochemical cell 800 (e.g., structurally and/or functionally similar to the electrochemical cells described herein, such as the electrochemical cell stack 200 of FIGS. 2A-2G) in an electrochemical cell terminal folding device 890, according to an embodiment. The folding device 890 includes terminal manipulators 838 (e.g., structurally and/or functionally similar to the terminal manipulator 738 of FIGS. 7D-7M). In some embodiments, the terminal manipulators 838 are operated by a pneumatic system. In some embodiments, the terminal manipulators 838 are operated by a robotic system. The terminal manipulator 838 in FIG. 8 is coupled to a terminal 816 (e.g., structurally and/or functionally similar to the terminals described herein, such as the terminals 216a, 216b of FIGS. 2A-2G).

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
a first electrode;
a second electrode different than the first electrode;
a separator between the first electrode and the second electrode; and
an electrode tab electrically coupled to at least one of the first electrode or the second electrode, at least a portion of the electrode tab folded to form a folded portion.

2. The electrochemical cell of claim 1, wherein the folded portion includes a first portion, a second portion substantially parallel to the first portion, and a third portion coupled to the first portion and the second portion, the third portion inclined at an angle with respect to the first and second portions.

3. The electrochemical cell of claim 1, wherein the folded portion includes a first portion, a second portion, and third portion between the first and second portions, each of the first, second, and third portions being substantially parallel to each other.

4. The electrochemical cell of the claim 3, wherein:
a first side of the third portion is in contact with a corresponding side of the first portion, and
a second side of the third portion opposite the first side is in contact with a corresponding side of the second portion.

5. The electrochemical cell of claim 1, wherein each of the first electrode and the second electrode include corresponding current collectors, the electrode tab electrically coupled to the current collector of the at least one of the first electrode or the second electrode.

6. The electrochemical cell of claim 1, further comprising:
a terminal tab electrically coupled to the electrode tab, the terminal tab and the electrode tab forming a terminal assembly.

7. The electrochemical cell of claim 6, wherein at least a portion of the terminal tab is configured to overlap or envelop at least a portion of the electrode tab.

8. The electrochemical cell of claim 6, wherein the terminal tab and the electrode tab are electrically coupled to each other at a coupling location via at least one of a weld or an electrically conductive adhesive.

9. The electrochemical cell of claim 1, wherein the first electrode, the second electrode, the separator, and the electrode tab collectively form a unit cell, the electrochemical cell further comprising:
a pouch at least partially enveloping the unit cell, the folded portion of the electrode tab disposed outside an internal volume defined by the pouch.

10. An electrochemical cell assembly, comprising:
a first electrode paired with a second electrode via a separator, the first electrode, the second electrode, and the separator collectively forming a unit cell;
a pouch defining an internal volume within which the unit cell is disposed;
a tab extending from the unit cell to a region outside of the internal volume, the tab electrically coupled to at least one of the first electrode or the second electrode, a portion of the tab disposed at least partially outside the internal volume being folded to form a folded portion; and
a terminal assembly disposed outside the internal volume, the terminal assembly including a terminal tab electrically coupled to the folded portion of the tab.

11. The electrochemical cell assembly of claim 10, further comprising:
a plurality of unit cells disposed in the pouch; and
a plurality of tabs, each of the plurality of tabs electrically coupled to a corresponding unit cell of the plurality of unit cells.

12. The electrochemical cell assembly of claim 11, wherein:
the pouch is a stack pouch, and
each of the plurality of unit cells is disposed in a corresponding unit cell pouch, each of the corresponding unit cell pouches disposed within the internal volume, each of the plurality of tabs extending outside of each corresponding unit cell pouch.

13. The electrochemical cell assembly of claim 12, wherein the folded portion of the tab of each of the plurality of unit cells is disposed at least partially within an internal volume defined by the corresponding unit cell pouches.

14. The electrochemical cell assembly of claim 12, wherein:
the plurality of tabs are coupled together in a bail, and
the folded portion includes a folded portion of the bail.

15. The electrochemical cell assembly of claim 14, wherein the folded portion of the bail is disposed partially inside the stack pouch.

16. The electrochemical cell assembly of claim 12, wherein the plurality of tabs are electrically coupled to each other at a coupling region via at least one of a weld or an electrically conductive adhesive.

17. A method, comprising:
loading an electrode stack into a stack pouch bottom;
folding terminals of the electrode stack over an edge of the stack pouch bottom;
applying a stack pouch top to the electrode stack opposite of the pouch bottom; and
sealing the folded terminals between the stack pouch bottom and the stack pouch top.

18. The method of claim 17, further comprising:
pre-folding the terminals of the electrode stack.

19. The method of claim 17, further comprising:
coupling terminal manipulators to the terminals, wherein the terminal manipulators are configured to fold the terminals.

20. The method of claim 19, further comprising:
removing the terminal manipulators.

21. The method of claim 17, wherein folding the terminals of the electrode stack includes folding the terminals into a z-shape.

22. The method of claim 21, wherein folding the terminals of the electrode stack includes:
indexing the terminals upwards;
indexing the terminals inwards; and
indexing the terminals downwards.

23. The method of claim 17, wherein sealing the folded terminals includes heat sealing.

24. The method of claim 17, further comprising:
coupling the terminals at a coupling region via a weld, the weld configured to facilitate the folding of the terminals.
